(19) United States
(12) Patent Application Publication
(10) Pub. No.: US 2005/0225475 A1
(43) Pub. Date: Oct. 13, 2005

(54) Monitoring system for land-based navigational and landing systems

(76) Inventors: Erich Franke, Konigsbach-Stein (DE); Steffen Koller, Stuttgart (DE); Martine Montaron, Saint-Aubin (FR)

Correspondence Address: CENTRAL COAST PATENT AGENCY, PO BOX 187, AROMAS, CA, 95004, US

(21) Appl. No.: 10/470,630

(22) Filed: Aug. 5, 2004

(30) Foreign Application Priority Data
Aug. 6, 2003 (DE) 01390016US

(51) Int. Cl. G01S 13/00

(52) U.S. Cl. 342/33; 342/35; 342/52; 342/55; 342/58

(57) ABSTRACT

The present invention relates to a monitoring system for land-based navigational and landing systems. A monitoring system of this type monitors the functions that are carried out by the navigational and landing system, especially the information that is transmitted to the aircraft. According to the present invention, external interfering influences that are independent of the system are detected and are taken into account in the monitoring.

The present invention relates to a monitoring system for land-based navigational and landing systems. In navigational and landing systems of this type, some examples of which can be assumed to be familiar, such as the ILS, i.e., “Instrument Landing System” or the MLS, i.e., “Microwave Landing System”, monitoring systems are installed which continuously monitor and evaluate the functions that are being executed by the navigational or landing system itself, i.e., especially the transmission and reception of information via the antennae of the system. In the case of a landing system of the aforementioned type, radio signals are transmitted which convey to aircraft that are in the landing area specific necessary information regarding the location and course, in particular the localizer course and glide angle of the upcoming landing.

In view of the conditions that are standard in air traffic, which are a function, on the one hand, of location, time, weather, and traffic, and, on the other hand, of existing safety regulations, great demands are placed on the operational reliability of the navigational and landing systems. This is so above all when a landing is to take place automatically, without ground visibility, i.e., under the control of the so-called autopilot.

The known navigational and landing systems that are currently in operation, and those systems that are going to be operational, are designed for continuous use and a high degree of availability.

For this purpose, these systems are equipped with double transmitters as well as a transmitting antenna for broadcasting the appropriate signals.

A further safety measure designed to avoid the transmission of false course and landing information lies in continuously monitoring the transmitted signals using a monitoring device, the so-called monitor, which is native to the system. This takes place as continuous monitoring. As soon as the monitoring device ascertains a deviation of the signal from the parameters of the setpoint value, the system automatically switches to the second transmitter, as mentioned above, (a so-called “switchover”) or the system is switched off (a so-called “shutdown”). In particular, the devices that exist for this purpose must evaluate both the system-internal signals, the signals that are coupled from the transmitter elements as the so-called “Integral Monitor,” as well as the signals that are received in the “near field” or “next field” and the so-called “far field,” and it must compare the values that are obtained in this way with the required setpoint values; the evaluation results of this comparison are then determinative for any possible switchover or shutdown.

In addition, land-based navigational and landing systems of this type are usually equipped with a so-called “Remote Monitoring System,” which makes it possible to install other, external display devices, e.g., in the so-called airport “technical room” or in maintenance areas, where system conditions can be monitored and controlled.

Because land-based navigational and landing systems such as the aforementioned ILS and MLS systems are designed for continuous use and high availability, it is characteristic of the systems that information that is transmitted by them to individual aircraft is classified as “safety-critical.” This means that especially in the scope of operation falling under categories CAT II and CAT III, in which a landing can take place without sight of ground, i.e., under the control of the autopilot, every disturbance of the system can be detected, recorded, and unambiguously categorized as a defect or some other disturbing event. As is well-known, for this purpose the mean time between system failures or system shutdowns, the so-called “MTBO,” or “Mean Time Between Outages,” is used as a criterion.

In all the above comments, it has been predominantly system-internal, i.e., system-native, events that have been cited for the so-called monitoring. However, it is easy to see that events occurring outside of the system and not under the influence of the system can also have an effect on the broadcast transmission signals and the controls. It has been found that the proportion of events caused in this manner so as not to be identifiable and that resulted in a system shutdown or switchover, amount to between 20 and 40%.

The objective of the present invention lies in creating a monitoring system for land-based navigational and landing systems of the type cited above which can identify and evaluate failures of navigational and landing systems of this type that are caused by external influences.

This objective is achieved in that additional sensors for detecting environmental conditions and events in the area of influence of the navigational and/or landing system are connected to the monitoring system, the information from the sensors detected in this manner being recorded and stored such that this information can be linked to the functional sequences of the navigational and landing system being detected and recorded at the same time.

As was indicated above, since the cause of failure, i.e., its unambiguous identification, exerts a determinative influence on the self-evaluation of the system and the scope of operation that is permitted, the advantages that can be achieved by the invention both from the operational as well as the economic points of view are easy to appreciate. A further advantage can be seen in the fact that, especially with existing systems, equipping a system in the manner suggested by the present invention can be accomplished using modules, in other words, therefore, without significant changes in existing system parts. Further details and useful embodiments of the monitoring system according to the present invention can be seen from the subclaims 2 through 8 and from the following description.

In connection to the features indicated in subclaims 2 through 8, a number of cases of interference from external causes are described below by way of example. To determine the cause of an interference, it is above all important that the appropriate sensors be installed at the appropriate places in the area to be monitored. For example, if the goal is to prevent unauthorized persons, vehicles, or animals from being or moving in the transmission range of the antennae, then optical sensors, e.g., in the form of one or more video cameras, will be the logical choice. Similarly, in such cases, it will also be possible to employ acoustical alarms either by themselves or as supplements.

Of course, with regard to optical and acoustic sensors, it is obviously ill advised to limit their range of sensitiveness to visible or audible events; thus, for example, night-vision devices or seismic sensors can also be used.

A further example especially includes cases of interference caused by the weather. In this regard, it is natural to provide sensors for measuring the temperature, the velocity and direction of the wind, the quantity of precipitation or snowfall, and icing. Similarly, suitable sensors for detecting storms, especially lightning strikes, can be used. Furthermore, it is useful to provide electromagnetic sensors that can aid in detecting, e.g., interference fields resulting from radiation.

Considering the number and variety of events to be detected, it seems advantageous to detect, record, and evaluate these events in one centralized, appropriately equipped data processing system. The term “appropriate equipment” here generally refers to storage capacity, processing speed, and statistical evaluating capacity. In this context, it is obvious that it must be possible to feed the detected events and their evaluation to the specific monitoring system in question, for initiating the necessary switching processes, and if necessary, for generating an optical display. The aforementioned statistical evaluating capacity is provided both for central as well as for individual processing, the evaluation results being used for purposes ranging from simple display to processing in setting up computer tutorials.

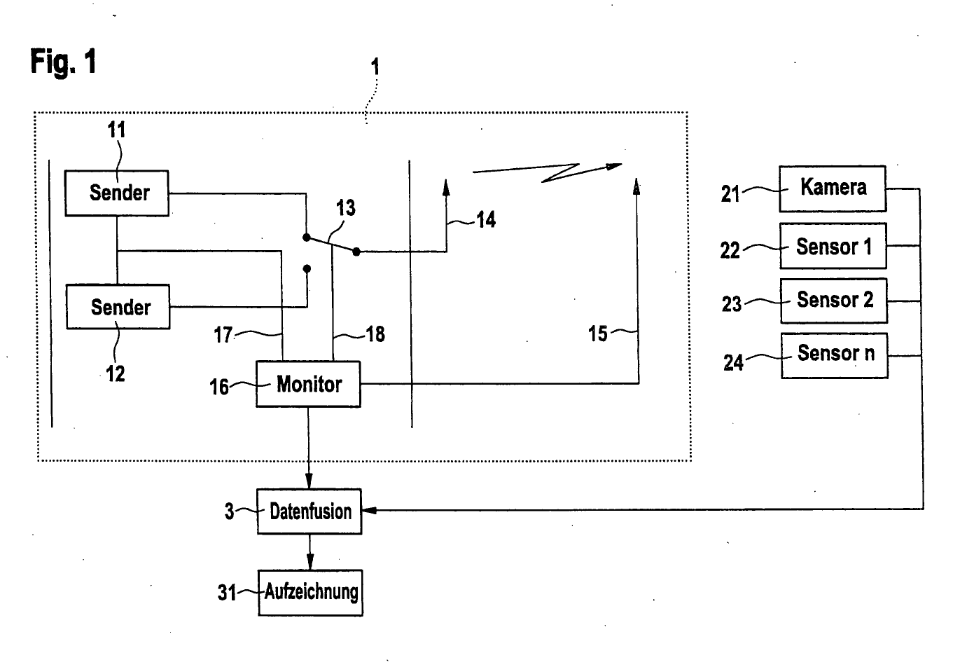

Depending on the application goal of the evaluation results, the latter may be brought into connection with the location and time of recording. In the attached drawing, in FIG. 1, a schematic representation of the system according to the present invention is depicted.

In Block 1, the system-internal functions are shown. Among them are two transmitters 11 and 12, both of which are connected to a change-over switch 13 for the connection to antenna 14. Antenna 14 is a transmitting antenna. Antenna 15 is a receiving antenna, which receives the signals that are transmitted from antenna 14 and conveys them to monitoring device 16, designated as Monitor. In addition, the signals from transmitters 11 and 12 are also directly fed to monitor 16 by a line 17. Line 18 makes it possible, independent of the evaluation results in monitor 16, i.e., the monitoring device, to switch from one transmitter 12 to the other. This was already discussed in some detail above.

In agreement with the present invention, the sensors that are provided for monitoring events outside the system are only indicated as 21, 22, 23, and 24, by way of example. These sensors 21 through 24, which were described above in their functions, are all connected to a central data processing system 3, designated here as data fusion, and they feed their output signal to it. In addition, the evaluation results of monitor 16 are fed to data fusion 3 and are evaluated as described above from multiple points of view. Furthermore, yet another recording device 31 is connected to data fusion 3, the recording device recording in detail the evaluation results of data fusion 3 as well as, if appropriate, of the sensors, etc. Undepicted is the possibility of an acknowledgment message sent from data fusion 3 to monitor 16 for display on individual systems or for further utilization.

1. A monitoring system for land-based navigational and landing systems, in which the functions exercised by a navigational or landing system of this type, especially the transmission and reception of information via the antennae of the system, are continually monitored and evaluated,
wherein additional sensors for detecting environmental conditions and events in the area of influence of the navigational and/or landing system are connected to the monitoring system, information from the sensors gathered in this manner being recorded and stored such that this information can be linked to the specific functional sequences of the navigational and landing system that are detected and recorded at the same time.

2. The monitoring system as recited in claim 1,
wherein sensors for recording optical, acoustic, electromagnetic, and/or general physical processes, especially weather-related events, are installed.

3. The monitoring system as recited in claim 1 or 2,
wherein the operating data and the detected data reflecting the environmental conditions and environmental events of a plurality of navigational and landing systems are transmitted to one central recording and evaluating device.

4. The monitoring system as recited in claim 1,
wherein the collected and evaluated data can be displayed on monitors and/or can be used for preestablished, automatic switching processes within the system area.

5. The monitoring system as recited in claim 4,
wherein the collected and evaluated data and/or the switching processes that result therefrom are classified and statistically evaluated and can be utilized individually or in predetermined combinations in a tutorial of a central data processing system.

6. The monitoring system as recited in claim 4 or 5,
wherein the collected and evaluated data can be collected and linked in time-dependent event sequences.

7. The monitoring system as recited in claim 4 or 5,
wherein the collected and evaluated data are classified in accordance with the location of their origin, or detection.

8. The monitoring system as recited in claim 4 or 5,
wherein the collected and evaluated data can be linked to generally available information such as the time of day, season, or topography.
